(19) United States
(12) Patent Application Publication
(10) Pub. No.: US 2016/0231772 A1
(43) Pub. Date: Aug. 11, 2016

(54) WEARABLE ELECTRONIC DEVICE AND TOUCH OPERATION METHOD

(71) Applicant: MediaTek Inc., Hsin-Chu (TW)

(72) Inventor: Xuan-Lun HUANG, Zhubei City (TW)

(21) Appl. No.: 14/886,211

(22) Filed: Oct. 19, 2015

Related U.S. Application Data
(60) Provisional application No. 62/113,603, filed on Feb. 9, 2015.

(51) Int. Cl. G06F 1/16; G06F 3/0488; G06F 3/041

(52) U.S. Cl. CPC G06F 1/163; G06F 3/0412; G06F 3/0416; G06F 3/0488

(57) ABSTRACT

A wearable electronic device is provided. The wearable electronic device includes a touch display panel, a touch bezel and a processor. The touch display panel is configured to sense at least one first touch event and display content. The touch bezel is disposed around the touch display panel and configures to sense at least one second touch event. The processor is configured to generate at least one control signal according to a combination of at least one scenario occurring on the touch display panel and the at least one second touch event, and control the wearable electronic device to perform at least one operation in response to the at least one control signal.

### CROSS REFERENCE TO RELATED APPLICATIONS

This application claims the benefit of U.S. Provisional Application No. 62/113,603 filed on Feb. 9, 2015, the entirety of which is incorporated by reference herein.

### BACKGROUND OF THE INVENTION

1. Field of the Invention

The disclosure generally relates to a wearable electronic device, and more particularly, to a touch operation method for controlling the operation of a wearable electronic device.

2. Description of the Related Art

Wearable electronic devices which provide functions such as communication, gaming and photography are getting more popular nowadays. A wearable electronic device may use a communication network to communicate with other electronic devices, for example, to initiate another electronic device, access remotely-stored data, or provide locally-stored data. However, due to the limited display area and limited volume of the wearable electronic device, it is not convenient for users to utilize certain functions such as communication, gaming and photography on the wearable electronic device. Therefore, an efficient and user-friendly touch operation method for the wearable electronic device is needed.

### BRIEF SUMMARY OF THE INVENTION

The disclosure proposes a touch operation method for controlling a wearable electronic device. The touch operation method can sense one or more touch events on the touch display panel and/or the touch bezel to control the wearable electronic device. The touch operation method can solve the aforementioned problem.

In one aspect of the disclosure, a wearable electronic device is provided. The wearable electronic device includes a touch display panel, a touch bezel and a processor. The touch display panel is configured to sense at least one first touch event and display content. The touch bezel is disposed around the touch display panel and configures to sense at least one second touch event. The processor is configured to generate at least one control signal according to a combination of at least scenario occurring on the touch display panel and the at least one second touch event occurring on the touch bezel, and control the wearable electronic device to perform at least one operation in response to the at least one control signal.

In some embodiments, at least one scenario occurring on the touch display panel comprises the at least one first touch event occurring on the touch display panel. In some other embodiments, the at least one scenario occurring on the touch display panel comprises a content currently displayed on the touch display panel.

In some embodiments of the disclosure, in controlling the wearable electronic device to perform the at least one operation in response to the at least one control signal, the processor determines a content subsequently displayed on the touch display panel according to the combination of the at least one first touch event and the at least one second touch event.

In some embodiments of the disclosure, the combination of the at least one first touch event and the at least one second touch event comprises the at least one first touch event and the at least one second touch event occurring simultaneously. In other embodiments, the combination of the at least one first touch event and the at least one second touch event comprises the at least one first touch event and the at least one second touch event occurring sequentially.

In some embodiments of the disclosure, in generating the at least one control signal according to the combination of the at least one first touch event and the at least one second touch event, the processor determines a first gesture according to the at least one first touch event and determines a second gesture according to the at least one second touch event, and generates the at least one control signal according to a combination of the first gesture and the second gesture. In other embodiments, in generating the at least one control signal according to the combination of the at least one first touch event and the at least one second touch event, the processor determines a gesture according to a combination of the at least one first touch event and the at least one second touch event, and generates the at least one control signal according to the gesture.

Moreover, in the embodiments, in generating the at least one control signal according to the combination of the at least one first touch event and the at least one second touch event, the processor generates the at least one control signal further according to at least one of a currently-executed application and/or a currently-occurring scenario and a detection of whether a right hand or a left hand is holding the wearable electronic device, and the at least one currently-occurring scenario comprises a content currently displayed by the touch display panel.

In some embodiments of the disclosure, the processor further judges whether a predetermined unlocking condition is met by the combination of the at least one first touch event and the at least one second touch event, and when the predetermined unlocking condition is met, the processor generates the at least one control signal for unlocking another device.

In some embodiments, the at least one second touch event comprise a combination of at least one first sub-touch event occurring on a first portion of the touch bezel and at least one second sub-touch event occurring on a second portion of the touch bezel, and the at least one operation comprises texting, zooming, rotating and/or scrolling.

In another aspect of the disclosure, a touch operation method for a wearable electronic device is provided. The touch operation method includes sensing at least one first touch events and displaying a content by a touch display panel; sensing at least one second touch event by a touch bezel which is disposed around the touch display panel; generating at least one control signal according to at least one scenario occurring on the touch display panel and the at least one second touch event by a processor; and controlling the wearable electronic device to perform at least one operation in response to the at least one control signal by the processor.

In the embodiments, since the touch bezel provides one or more extra touch areas, users can access the wearable electronic device more easily and conventionally. In addition, at least one scenario occurring on the touch display panel and at least one touch event occurring on the touch bezel can be considered in a combined way to determine a corresponding operation of the wearable electronic device. In other words, the touch bezel and the touch display panel can operate in a more integrated way, thus allowing users to operate the wearable electronic device in a more intuitive, fluent, and elegant way. Furthermore, the touch bezel and the touch display panel can be physically integrated to have a more integrated and hence stylish appearance.

In another aspect of the disclosure, a mobile electronic device is provided, comprising: a display panel, configured to display contents; a processor, configured to detect whether a right hand or left hand is wearing/holding the mobile electronic device and provide different provide different user interfaces for the same functionality when a right hand or left hand is detected to wear/hold the mobile electronic device, wherein the different user interfaces for the same functionality comprise different contents for the same functionality displayed on the display panel.

In one embodiment, the different contents for the same functionality displayed on the display panel comprise at least one partial content for the same functionality displayed closer to one side of the display panel when a right hand is detected to wear/hold the mobile electronic device and one opposite side of the display panel when a left hand is detected to wear/hold the mobile electronic device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating the appearance of the wearable electronic device according to an embodiment of the invention;

FIG. 2A is a schematic diagram illustrating the appearance of a wearable electronic device according to an embodiment of the invention:

FIG. 2B is another schematic diagram illustrating the appearance of a wearable electronic device according to an embodiment of the invention:

FIG. 3 is a schematic diagram illustrating a detailed structure of a wearable electronic device according to an embodiment of the invention:

FIG. 4A is a schematic diagram illustrating a security application for a wearable electronic device according to one embodiment;

FIG. 4B is a diagram showing an example unlocking operation corresponding to FIG. 4A;

FIG. 5 is a schematic diagram illustrating a texting operation for a wearable electronic device according to some embodiments;

FIG. 6 is a flowchart illustrating another touch operation method for controlling a wearable electronic device according to an embodiment of the invention:

FIG. 7A to FIG. 7E are schematic diagrams illustrating various kinds of gestures for a wearable electronic device according to some embodiments of the invention;

FIG. 8 is a schematic diagram illustrating a texting operation for a wearable electronic device according to some embodiments:

FIG. 9A is a schematic diagram illustrating another texting operation for a wearable electronic device according to other embodiments;

FIGS. 9B and 9C are diagrams showing different example texting operations performed corresponding to FIG. 9A;

FIG. 10 is a flowchart illustrating another touch operation method for controlling a wearable electronic device according to an embodiment of the invention; and

FIGS. 11A and 11B an example diagram of a mobile electronic device according to an embodiment, illustrating that different user interfaces provided when different hands are holding/wearing the mobile electronic device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE INVENTION

The following description is of the best-contemplated operation of carrying out the invention. This description is made for the purpose of illustrating the general principles of the invention and should not be taken in a limiting sense. Certain terms and figures are used throughout the description and following claims to refer to particular components. As one skilled in the art will appreciate, manufacturers may refer to a component by different names. This document does not intend to distinguish between components that differ in name but not function. The terms “component”. “system” and “device” used in the present invention could be the entity relating to the computer which is hardware, software, or a combination of hardware and software. Accordingly, when one device is coupled to another device, that connection may be through a direct electrical connection, or through an indirect electrical connection via other devices and connections.

In embodiments of the disclosure, a touch bezel and a touch display panel 120 can be utilized in combination. More specifically, at least one scenario occurring on the touch display panel and at least one touch event occurring on the touch bezel can be considered in a combined way to determine a corresponding operation of the wearable electronic device. For example, in some of the embodiments, the wearable electronic device 10 can have an operation corresponding to a combination of at least one first touch event occurring on the touch display panel 120 and at least one second touch event occurring on the touch bezel. In some other embodiments of the embodiments, the wearable electronic device 10 can have an operation corresponding to a combination of at least one touch event occurring on the touch bezel 110 and content currently displayed on the touch display panel 120. Accordingly, the touch bezel 110 and the touch display panel 120 can operate in a more integrated way.

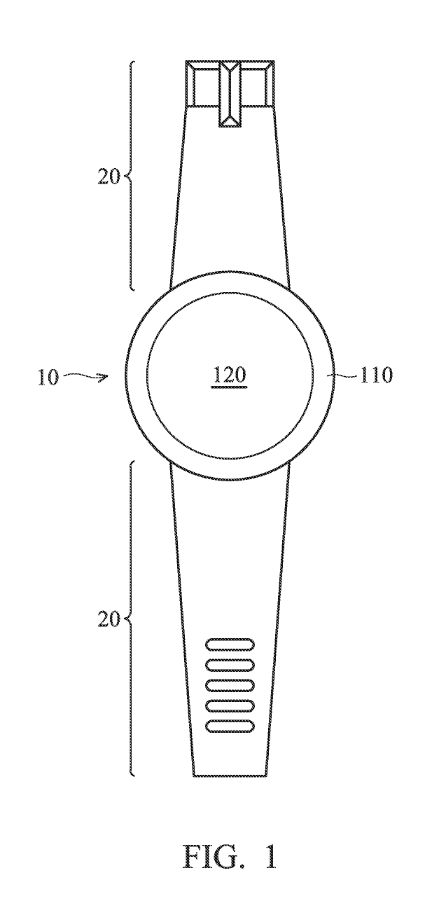

FIG. 1 is a schematic diagram illustrating the appearance of the wearable electronic device 10 according to an embodiment of the invention. The wearable electronic device 10 is suitable to be worn on the user's body, such as wrist or head. As an example, the wearable electronic device 10 is shown as a wristband in the embodiment of FIG. 1, but the disclosure is not limited thereto. For example, the wearable electronic device 10 can be any other type of wearable device, such as glasses, watches, sports accessories, etc. The wearable electronic device 10 may perform various functions related to techniques, methods and systems described in different embodiments of the disclosure.

As shown in FIG. 1, the wearable electronic device 10 can include a touch bezel 110 and a touch display panel 120 around which the touch bezel 110 is disposed. It is noted in the embodiments and in other embodiments of the disclosure, the touch bezel 110 can be any shape in different designs. The touch display panel 120 is configured to display content which may be provided by a processor. Specifically, the touch display panel 120 can be configured to display information content to be provided by the wearable electronic device 10 and/or any messages or contents that can enable operation, communication, or interaction by the user with the wearable electronic device 10.

In addition, the touch display panel is also configured to sense at least one first touch event. In other words, the touch display panel 120 can be a touch-sensitive display that can not only output information to the user but can also receive input from the user. For example, the touch display panel 120 could include a resistive touch panel, a capacitive touch panel, an optical touch panel or an electromagnetic touch panel. In some implications, at least one touch sensor could be arranged within the touch bezel 110 to detect the touch input from the user. For example, the touch sensor could be a resistive touch sensor, a capacitive touch sensor, an optical touch sensor or an electromagnetic touch sensor.

As will be described in embodiments below, the touch bezel 110 and the touch display panel 120 can be utilized in combination. More specifically, in some embodiments, the wearable electronic device 10 can have an operation corresponding to a combination of at least one first touch event occurring on the touch display panel 120 and at least one second touch event occurring on the touch bezel. In other embodiments, the wearable electronic device 10 can have an operation corresponding to a combination of at least one touch event occurring on the touch bezel 110 and content currently displayed on the touch display panel 120. In the embodiments, the touch bezel 110 and the touch display panel 120 can operate in a more integrated way.

In addition, according to design requirement, the touch bezel 110 and the touch display panel 120 can be separate components, or alternatively, they can be designed to have an integrated appearance. In other words, the touch bezel 110 and the touch display panel 120 can be more integrated in both operation and appearance.

Moreover, the wearable electronic device 10 can be connected to at least one supporting component 20. For example, the supporting component 20 could be a spire lamella as shown in FIG. 1. The supporting component 20 may provide a mechanical function such as supporting and/or connecting different components of the wearable electronic device 10. In addition, the supporting component 20 may provide a decorative or ornamental function. In different embodiments, the supporting component 20 includes a housing, a casing, a band, and/or a covering of the wearable electronic device 10. It is noted that the touch bezel 110, the touch display panel 120, and the at least one supporting component 20 can be designed as separate components, or alternatively, integrated at least partially. For example, the touch bezel 110 can be integrated with the housing, the casing or the covering. In other words, the term “touch bezel” may mean at least one of the bezel, the housing, the casing, the band and/or the covering of the wearable electronic device 10 having sensing ability.

Additionally, one or more environment detection components could be arranged within the wearable electronic device 10 or the supporting component 20. The environment detection component can include at least one image-capture device, a sensor (such as light sensor or color sensor, a temperature sensor, a humidity sensor), an barometer, an antenna, a GPS receiver, a wireless communication transceiver, a haptic device, an accelerometer, a speedometer, a health monitor, and/or any hardware/software device/module (a database or an application) capable of fetching or providing any environmental information, e.g., current time/date/location/temperature information.

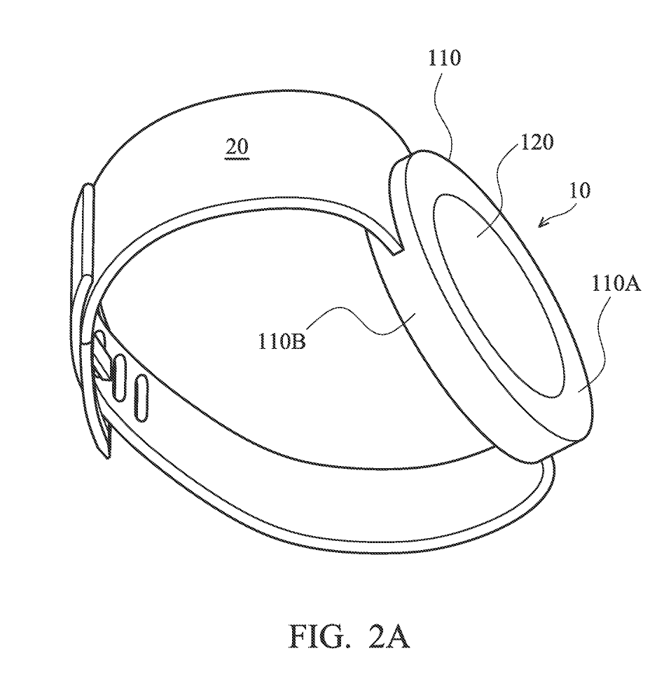

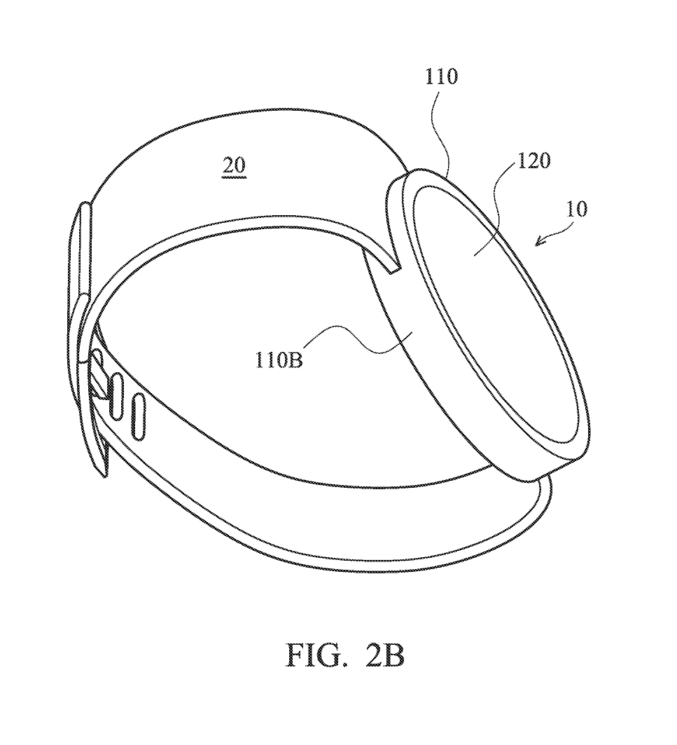

FIG. 2A is a schematic diagram illustrating the appearance of the wearable electronic device 10 according to an embodiment of the invention. In some embodiments, the touch bezel 110 includes two sub-touch bezels 110A and 110B. As shown in FIG. 2A, the sub-touch bezel 110A is approximately on the same plane as the touch display panel 120. The sub-touch bezel 110A is arranged on a plane which is different from the plane of the sub-touch bezel 110B. For example, the plane on which the sub-touch bezel 110B is arranged is perpendicular to the plane on which the sub-touch bezel 110A is arranged. In other words, from the point of view of the user, the sub-touch bezel 110A is located on the front side of the wearable electronic device 10, and the sub-touch bezel 110B is located on the lateral side or flanking side of the wearable electronic device 10. Various kinds of touch events could be conducted by the user through the sub-touch bezels 110A and 110B which are arranged in different positions of the wearable electronic device 10. Therefore, a user-friendly wearable electronic device 10 could be provided for users.

Specifically, in the embodiments of FIG. 2A, the user can operate the wearable electronic device 10 by touching the sub-touch bezel 110B on the lateral side. Because the touch bezel 110 could be arranged not only in two-dimensions but also in three-dimensions as shown in FIG. 2A, the user interface of the wearable electronic device 10 could be designed with more possibilities and could be more user-friendly. For example, the sub-touch bezel 110B could be touched by the thumb of the user to initiate a software application, and the sub-touch bezel 110A could be touched by the forefinger of the user to operate the software application accordingly.

It should be noted that the areas and shapes of the sub-touch bezels 110A and 110B could be changed for various kinds of designs of the wearable electronic devices 10. FIG. 2B is another schematic diagram illustrating the appearance of the wearable electronic device 10 according to an embodiment of the invention. In this embodiment of FIG. 2B, the sub-touch bezel 110B is provided without arranging the sub-touch bezel 110A. Since no area is occupied by the sub-touch bezel 110A, the touch display panel 120 could have a large area for displaying much content.

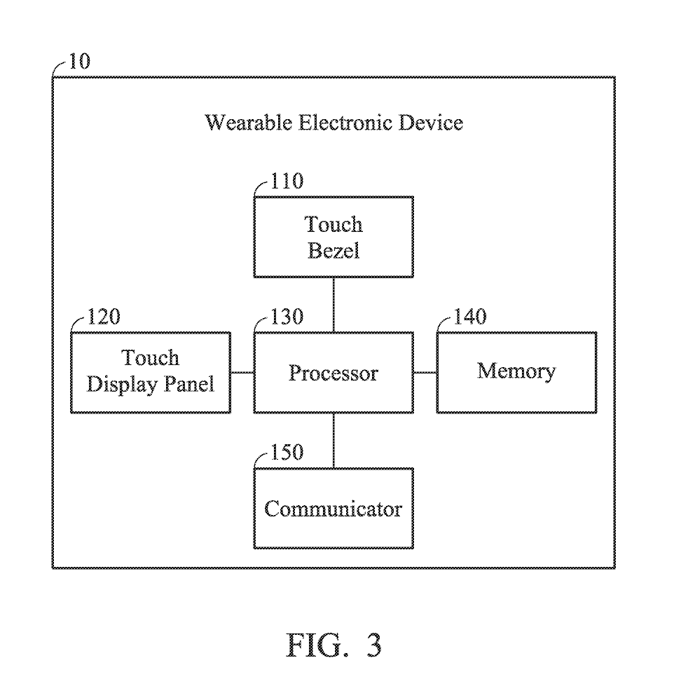

FIG. 3 is a schematic diagram illustrating a detailed structure of a wearable electronic device according to an embodiment of the invention. FIG. 3 may be applied in the embodiments through the disclosure but is not limited thereto. Since the embodiment of FIG. 3 can be implemented in the wearable electronic device 10 in FIG. 1, it is explained below using the same reference numbers used in FIG. 1 for convenience of explanation.

In some embodiments, the wearable electronic device 10 includes a touch bezel 110, a touch display panel 120, a processor 130. In addition, the wearable electronic device 10 can further include a memory 140 and a communicator 150. Although the touch bezel 110, the touch display panel 120, the processor 130, the memory 140 and the communicator 150 are illustrated as discrete components separate from each other, in various implementations of the wearable electronic device, at least some of these components may be integral parts of a single IC, chip or chipset.

The touch display panel 120 is configured to sense at least one first touch event and display content. The touch bezel 110 is disposed around the touch display panel 120 and is configured to sense at least one second touch event. The processor 130 is configured to generate at least one control signal according to a combination of at least one scenario and the second touch event, and control the wearable electronic device 10 to perform at least one operation in response to the control signal. The at least one scenario occurring on the touch display panel may include either or both of the at least one first touch event occurring on the touch display panel and a content currently displayed on the touch display panel. In some embodiments, in controlling the wearable electronic device 10 to perform at least one operation, the processor 130 can determine content subsequently displayed on the touch display panel 120 according to the combination of the first touch event and the second touch event and generates at least one control signal and generate at least one control signal based on the determination, e.g., for controlling the touch display panel 120 to display the determined content. In addition, the operation performed by the wearable electronic device 10 includes texting, zooming, rotating and/or scrolling. Because the scenario on the touch display panel 120 and the touch event on the touch bezel 110 can be considered in combination by the processor 130, the touch display panel 120 can operate in more integrated way, as will be explained more below.

Furthermore, the processor 130 could include a digital signal processor (DSP), a microcontroller (MCU), a central-processing unit (CPU) or a plurality of parallel processors relating the parallel processing environment to implement the operating system (OS), firmware, driver and/or other software applications of the wearable electronic device 10.

The memory 140 is utilized to store data generated when the wearable electronic device is operated such as texting. The memory 140 could include one or a plurality of a random access memory (RAM), a read-only memory (ROM), a flash memory or a magnetic memory. In addition, the communicator 150 is utilized to transmit data to other electronic devices and receive data from other electronic devices based on wireless communication protocols. The wireless communication protocol of the wearable electronic device 10 could constitute GSM. GPRS, EDGE, UMTS, W-CDMA, CDMA2000. TD-CDMA, Bluetooth, NFC, WiFi, WiMAX, LTE, LTE-A or TD-LTE.

In embodiments where the first touch event is considered as the scenario occurring on the touch display panel 120, the first touch event and the second touch event could occur simultaneously or sequentially. In other words, the first and second touch events occurring at the same or different times can be considered in combination.

In addition, in different embodiments, in generating at least one control signal according to a combination of the first touch event and the second touch event, the first touch event and the second touch event can be combined in different stages and forms. For example, the combination can occur before gestures are respectively identified for the first touch event and the second touch event. Alternatively, the combination can occur after the first and second events are considered in combination to identify a gesture. The gesture can be single or multi-touch gestures such as tape, click, scroll, drag, select, zoom, rotate, panning, and etc, as required by designs.

More specifically, in one embodiment, the processor 130 can determine a first gesture according to the first touch event and determines a second gesture according to the second touch event, and generates the control signal according to a combination of the first gesture and the second gesture. For example, a press on the touch display panel 120 and a rotate on the touch bezel 110 can be considered in combination to determine a corresponding operation of the wearable electronic device.

In another embodiment, the processor 130 determines a gesture according to a combination of the first touch event and the second touch event, and generates the control signal according to the gesture. For example, relative movements of touches simultaneously on the touch bezel 110 and the touch display panel 120 can be identified to be a specific gesture. Or the first and second touch events sequentially occur to across the touch bezel 110 and the touch display panel 120 can be identified to be a specific gesture.

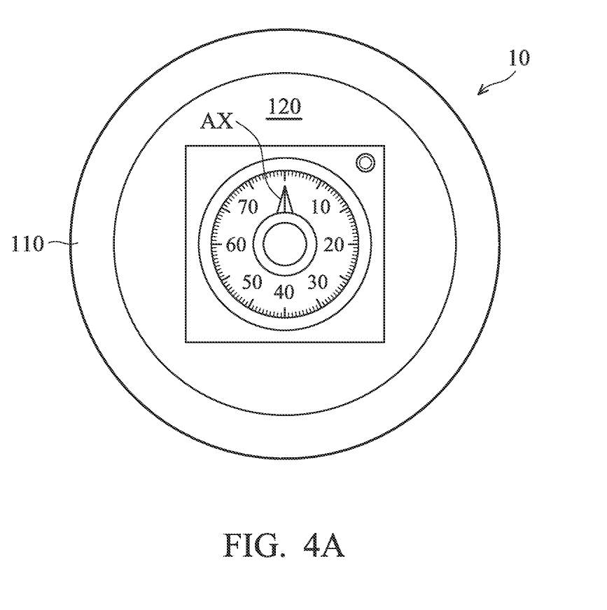

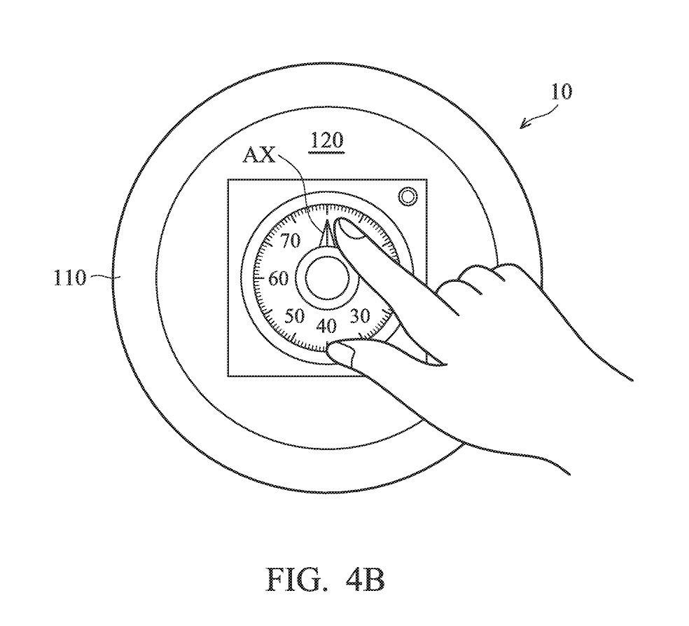

In some embodiments, the processor 130 generates the at least one control signal according to a combination of a touched region where the at least one first touch event occurs on the touch display region 120 and one or more rotations in the at least one second touch event occurring on the touch bezel 110. The processor 130 may further judges whether a predetermined condition is met according to the combination to control the wearable electronic device to perform a corresponding operation. For example, the processor 130 can judges whether a predetermined unlocking condition is met by the combination of the at least one first touch event and the at least one second touch event according to the detections. When the predetermined unlocking condition is met, the processor generates the at least one control signal for unlocking another device, as explained in FIG. 4.

FIG. 4A is a schematic diagram illustrating a security application of a wearable electronic device according to an embodiment. Since the embodiment of FIG. 4A can be implemented in the wearable electronic device of FIG. 1, it is explained below using the same reference numbers used in FIG. 1 for convenience of explanation but the disclosure it not limited thereto.

Compared with other kinds of electronic devices, the wearable electronic device 10 is closer to human body and is more privacy. As such, the wearable electronic device 10 could be a personal electrical key to unlock itself or unlock other electronic devices to improve the security. In some embodiments, the security application could be initiated by conducting the first touch event on the touch display panel 120 and the second touch event on the touch bezel 110 at the same time. Accordingly, the unlocking content of the security application could be displayed on the touch display panel as shown in FIG. 4. In the embodiment, after the processor 130 judges a predetermined unlocking condition is met, the processor 130 can generate a control signal for unlocking another electronic device or unlocking the wearable electronic device 10 by itself. The predetermined unlocking condition can include a series of numbers defined by the user.

In the embodiment of FIG. 4A, the unlocking can be performed by a sequence of rotating gestures representing the second touch event on the touch bezel 110. FIG. 4B is a diagram showing example unlocking operation. More specifically, when the user utilizes the security application, he may input multiple numbers in sequence to the wearable electronic device 10 by performing a sequence of rotations on the touch bezel 110. An indicator AX may be implemented to indicate a selected one of the numbers corresponding to each rotation in the second touch event. For example, the user can perform a clockwise rotation on the touch bezel 110 to increase the number for selection, and a counterclockwise wise rotation on the touch bezel 110 to decrease the number for selection. In some implementations, a press (by a thumb for example) can be required to be maintained on the touch display panel 120 during the rotations to imitate a typical unlocking action. Moreover, once a number has been selected by the user, a click or any gesture on either the touch display panel 120 (another first touch event) or the touch bezel 110 could be conducted to confirm the chosen number.

When each of the chosen numbers input by the user have met the predetermined unlocking condition, a control signal will be generated by the processor 130 to unlock the wearable electronic device 20 or to unlock other electronic devices. In brief, the unlocking can be performed by a sequence of rotating gestures on the touch bezel 110 in combination of a press maintained and/or a confirmation click on the touch display panel 120. Since the rotation does not leave any finger prints on the touch display panel 120, the security could be further improved. Therefore, an easy-accessing and reliable security application could be provided by the wearable electronic device 10 of the embodiment.

In some embodiments, a selection with respect to a displayed content can be performed by considering a combination of first touch event occurring on the touch display panel 110 and the touch bezel 120. This may used for realizing a texting operation. For example, a plurality of groups of characters can be displayed respectively on a plurality of portions on the touch display panel. The first touch event may correspond to a preliminary selection to select a group of characters the second touch event may correspond to a further selection to select one characters from the preliminarily selected group of characters. More specifically, And the processor 130 can generate the at least one control signal for selecting one character from the plurality of groups of characters according to a combination of a touched portion of the plurality of portions on the touch display panel 120 in the at least one first touch event on the touch display panel, and the at least one second touch event occurring on the touch bezel 130 for further selecting one character from the group of characters in the touched portion.

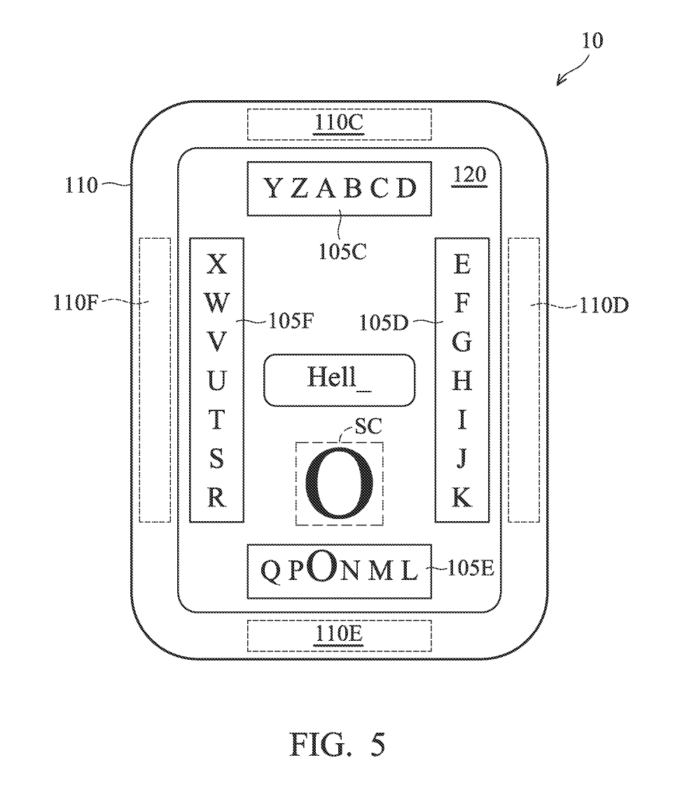

FIG. 5 is a schematic diagram illustrating a texting operation for the wearable electronic device according to some embodiments. Since the embodiment of FIG. 5 can be implemented in the wearable electronic device of FIG. 1, it is explained below using the same reference numbers used in FIG. 1 for convenience of explanation but the disclosure it not limited thereto.

When a plurality of characters are displayed on the touch display panel 120, in response to at least one first touch event occurring on a first portion of the touch display panel 120, the processor 130 determines which one or more characters among the characters are to be further selected. Moreover, in response to at least one second touch event occurring on a second portion of the touch bezel 110, the processor 130 determines which one character among the characters on the touch display panel 120 is selected. Furthermore, when the touch bezel 110 senses the touch event occurring sequentially or simultaneously on at least one portion of the touch bezel 110, the processor 130 determines to rotate, move, zoom in, zoom out, or scroll at least a portion of the content displayed on the touch display panel 120.

As shown in FIG. 5, the characters A-Z are divided into four groups, and the four groups are displayed in four portions 105C-105F along the four edge areas of the touch display panel 120. It should be noted that the arrangement of the characters is for illustration, not for limitation. The characters could also be arranged in a circle or in an ellipse corresponding to the shape of the touch display panel and the user interface. In this embodiment, the touch bezel 110 includes four portions 110C-110F corresponding to four portions 105C-105F or the four groups of characters respectively.

In an example that the user wants to type “O”, the user can first conducts a touch event by touching the portion 105E to select the group of the characters L-Q. Afterwards, the user could conduct another touch event on the touch bezel 120, for example by moving his finger on the touch bezel 120. To facilitate a further selection by the user, a corresponding character along with the moving by the user finger in the selected group of the characters L-Q can be rotated, scrolled or zoomed out on the touch display panel 110. In one embodiment, a zoom out o is performed on the selected character SC and displayed in a specific region on the touch display panel 120 as shown. Moreover, once a character has been selected by the user, a click or any gesture on either the touch display panel 120 (another first touch event) or the touch bezel 110 could be conducted to confirm the chosen character. Consequently, a user-friendly texting method can be provided by the wearable electronic device 10 for texting characters (including either or both of alphabetic and numeric characters), and the messages from the user could be edited and transmitted more conveniently.

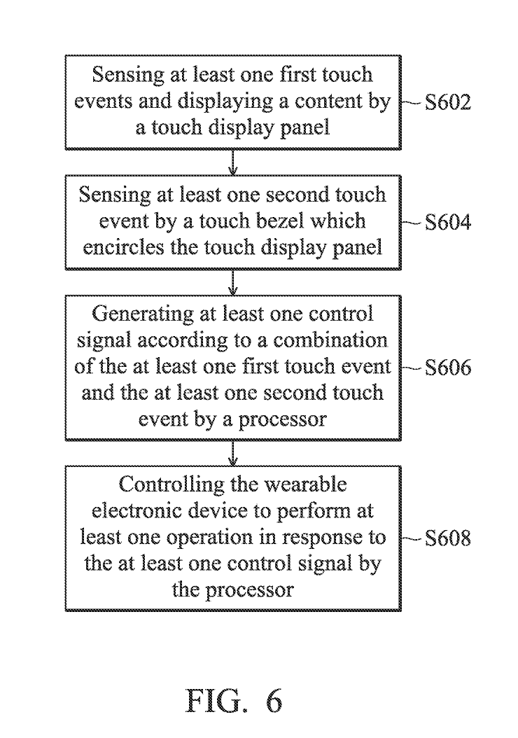

FIG. 6 is a flowchart illustrating a touch operation method for controlling a wearable electronic device 10 according to an embodiment of the invention. Although illustrated as discrete blocks, various blocks may be divided into additional blocks, combined into fewer blocks, or eliminated, depending on the desired implementation. FIG. 6 may be applied in the embodiments of FIG. 1-FIG. 5 but is not limited thereto. Since the embodiment of FIG. 6 can be implemented in the wearable electronic device 10 in FIG. 1, it is explained below using reference numbers used in the embodiment of FIG. 1 but is noted limited thereto.

In step S602, at least one first touch event is sensed and content is displayed on a touch display panel 120. In step S604, at least one second touch event is sensed by a touch bezel 110 which is disposed around the touch display panel 120. It should be noted that step S602 and step S604 could be executed simultaneously or sequentially. Afterwards, in step S606, at least one control signal is generated according to a combination of the first touch event and the second touch event by a processor 130. In step S608, the wearable electronic device 10 is controlled to perform at least one operation in response to the control signal by the processor 130. Details of each step may be analogized from the above embodiments, thus omitted here for brevity. Various kinds of operations have been illustrated and will not be repeated again.

In some embodiments where the content displayed on the touch display panel 120 is considered as the scenario occurring on the touch display panel 120, the processor determines to rotate, move, zoom in, zoom out, or scroll at least first part of the content displayed on the touch display panel according to the combination of a second part of the content displayed on the touch display panel 120 and the at least one first touch event occurring on the touch bezel 110. The at least first part of the content can be different from or the same as the at least one second part of the content.

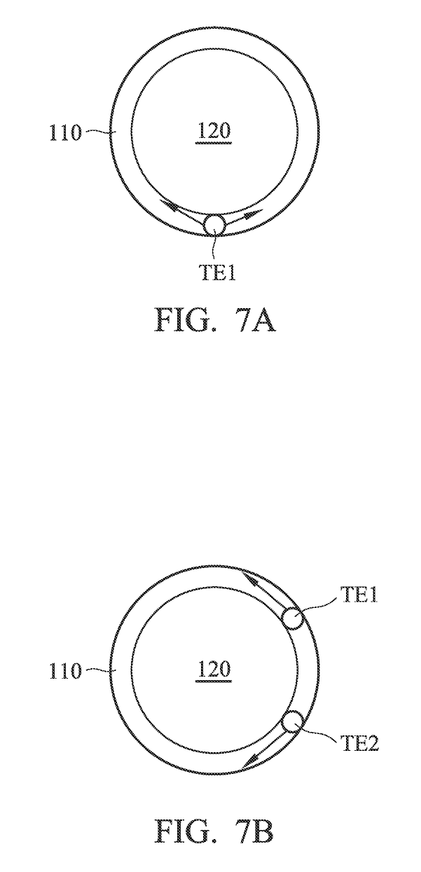

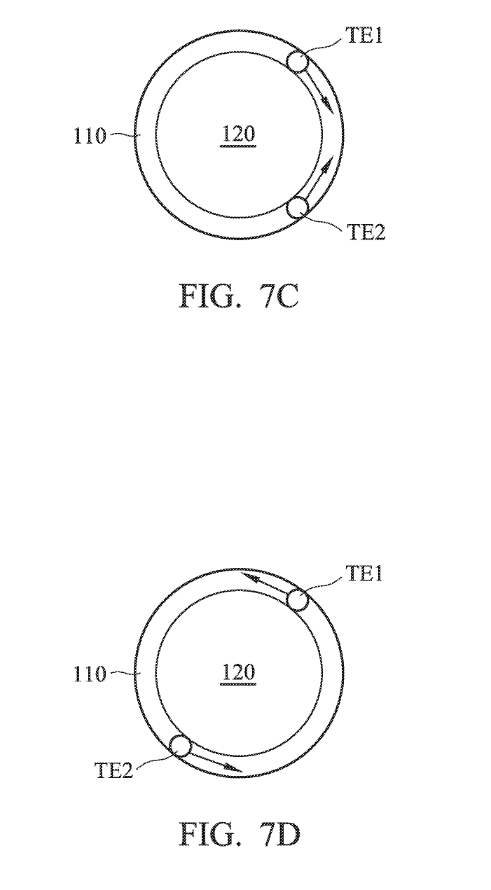

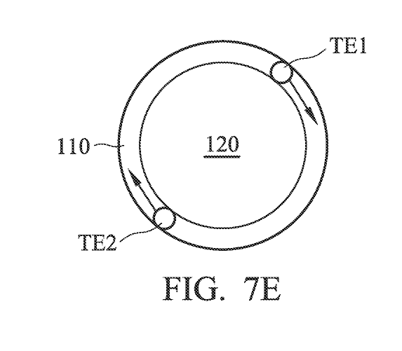

FIG. 7A to FIG. 7E are schematic diagrams illustrating various kinds of gestures for the wearable electronic device 10 according to some embodiments of the invention.

In the embodiment of FIG. 7A, a touch event TE1 is performed on the touch bezel 110, including a clockwise or counter-clockwise movement along the touch bezel 110. The processor 130 can then determine a gesture of scrolling and generate a control signal for controlling the touch display panel 120 to represent a scrolling operation on at least a part/an object of a currently-displayed content.

In the embodiments of FIG. 7B and FIG. 7C, two touch events TE1 and TE2 are detected by the touch bezel, including a clockwise movement and a counterclockwise movement simultaneously occurring along the touch bezel 110, and the other of the touch events TE1 and TE2 moves counter-clockwise along the touch bezel 110. The processor 130 can then determine gestures of zooming-out and zooming-in and generate a control signal for controlling the touch display panel 120 to represent a zooming-out operation and zooming-in operation on at least a part/an object of a currently-displayed content FIG. 7B and FIG. 7C, respectively.

In the embodiments of FIG. 7D and FIG. 7E, two touch events TE1 and TE2 are detected by the touch bezel, including two clockwise movements in FIG. 7D or two counterclockwise movements in FIG. 7E simultaneously occurring along the touch bezel 110. The processor 130 can then determine gestures of rotations and generate a control signal for controlling the touch display panel 120 to represent a switching-left operation and a switching-right operation on at least a part/an object of a currently-displayed content FIG. 7D and FIG. 7E, respectively.

It should be noted that the same touch event could be determined to represent different gestures or lead to different operations in different conditions/embodiments. For example, the touch events TE1 and TE2 in FIG. 7D could trigger rotating operation in some conditions, and also or alternatively be determined to trigger scrolling operations in other conditions. The mapping relationship between the touch events, the gestures, and operations could be determined and adjusted by users.

Moreover, it should be noted that in some embodiments, the touch events TE1 and TE2 are conducted on different portions of the touch bezel 110 simultaneously or sequentially. In other words, the at least one second touch event could include a combination of at least one first sub-touch event TE1 occurring on a first portion of the touch bezel 110 and at least one second sub-touch event TE2 occurring on a second portion of the touch bezel 110.

The sub-portions can be arranged in different places in different implementations. For example, in some embodiments as shown in FIG. 2A, the first sub-touch event could be conducted on the sub-touch bezel 110A, and the second sub-touch event could be conducted on the sub-touch bezel 110B. Various kinds and combinations of touch events could be detected by the wearable electronic device 10 to execute many different operations.

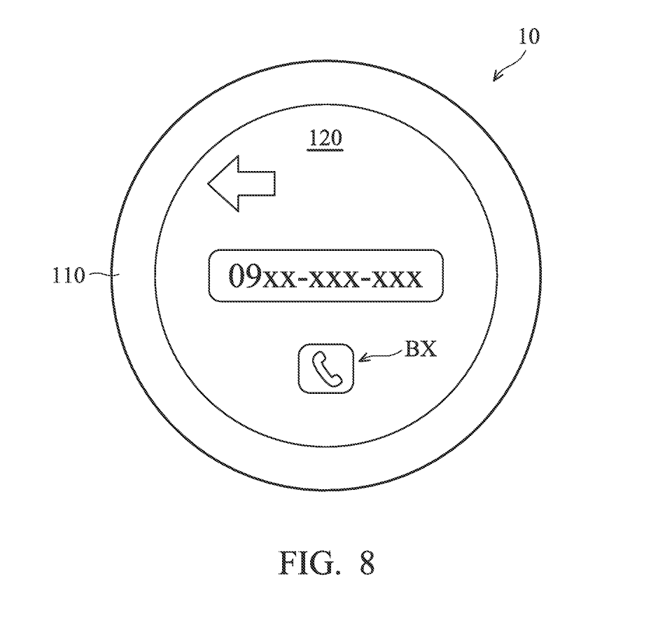

The consideration of the combination of a scenario on the touch display panel 120 and the touch bezel 110 in determining a corresponding operation can be utilized to realize various functions of the wearable electronic device 10, for example, a texting function. In one example implementation, a plurality of characters can be arranged to be displayed respectively on a plurality first sub-portions of the touch display panel 120. At the same time, the processor 130 can determine to sequentially display one character of the characters according to a combination of a touched portion of a plurality second portions of the touch bezel in at least one second touch event occurring on the touch bezel and the character currently displayed on the first portion of the touch display panel corresponding to (e.g., closest to) the touched portion of the touch bezel, as will explained more in embodiment of FIG. 8.

FIG. 8 is a schematic diagram illustrating a texting operation for a wearable electronic device according to some embodiments. FIG. 8 may be applied in the embodiments through the disclosure but is not limited thereto. Since the embodiment of FIG. 8 can be implemented in the wearable electronic device 10 in FIG. 1, it is explained below using

In a non-limiting example that a user wants to make a phone call, a texting operation can be performed by the wearable electronic device 10 for inputting phone numbers. As exemplarily illustrated, the phone numbers displayed on the touch display panel 120 could be arranged in the shape of circle close to the touch bezel 110, respectively in a plurality of portions of the touch display panel 120. When the user touches a portion of the touch bezel 110 nearest a specific number, which means the touched portion of the touch bezel is the portion nearest the located portion of the specific number in the touch display panel 120, causing a second touch event on the touch bezel 110 to occur, the specific number can be selected. With similar operations performed in a sequence, a sequence of number could be selected and input to the wearable electronic device 10.

Moreover, after all of the phone numbers are input, either or both of a first touch event on the touch display panel 120 or another second touch event on the touch bezel can be conducted for confirming the input or making calling. For example, the user may click an icon BX on the touch display panel 120 to conduct the first touch event. In response, a calling operation can be determined by the processor 130 to be performed. With such an implementation, a user-friendly texting method can be provided by the wearable electronic device 10 to input phone number and make a phone call.

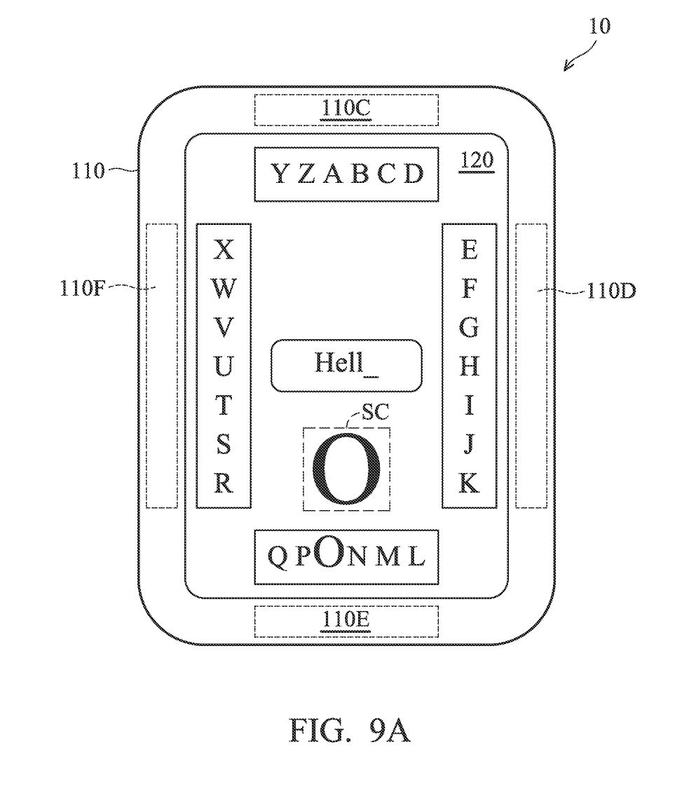

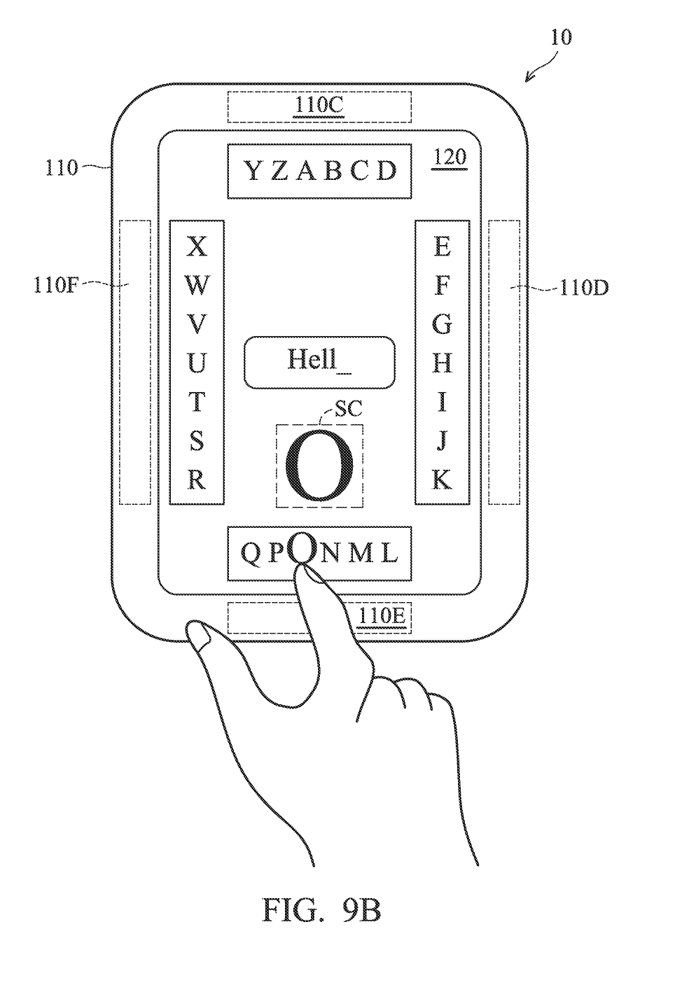

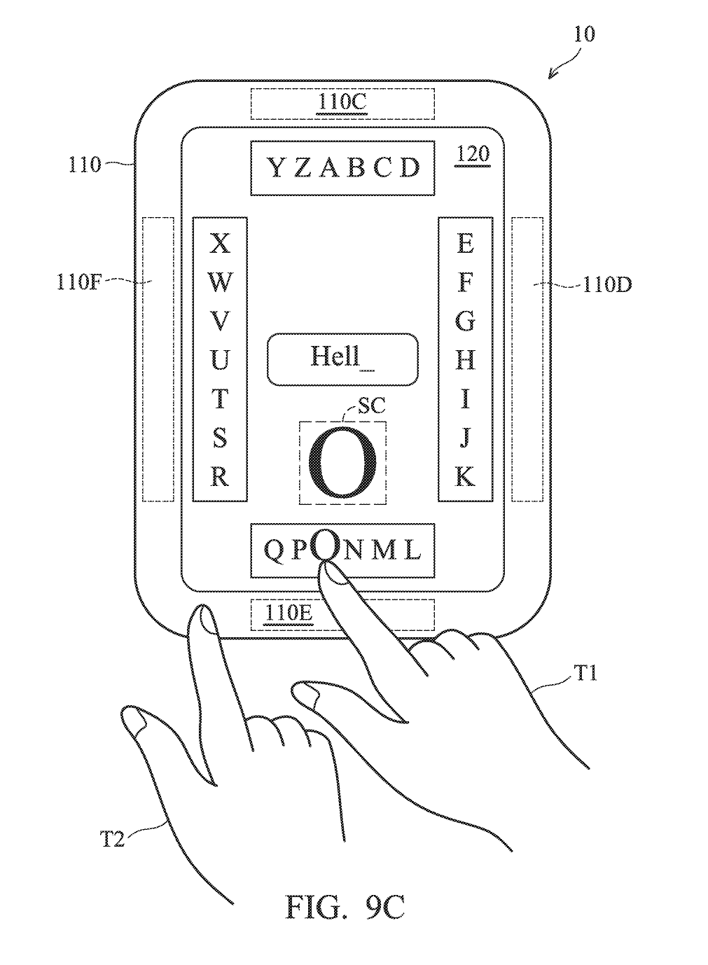

In another example implementation of texting, when a plurality of groups of characters are displayed respectively on a plurality of first portions on the touch display panel 120, the processor 130 generates the at least one control signal for selecting one character from the plurality of groups of characters according to a combination of a touched portion of a plurality of second portions on the touch display panel 120 in the at least one first touch event on the touch display panel 120, and the at least one second touch event occurring on the touch bezel 110 which are performed for further selecting one character from the group of characters in the second portion of the touch display panel 120 corresponding to (e.g., closest to) the touched portion of the touch bezel 110, as will be explained more in the embodiment of FIG. 9.

FIG. 9A is a schematic diagram illustrating a texting operation for the wearable electronic device according to some embodiments. Since the embodiment of FIG. 5 can be implemented in the wearable electronic device of FIG. 1, it is explained below using the same reference numbers used in FIG. 1 for convenience of explanation but the disclosure it not limited thereto.

FIG. 9A differs from FIG. 5 mainly in the selection in selecting the group of characters in the first step. Specifically, when a plurality of characters are displayed on the touch display panel 120, in response to at least one second touch event occurring on a first portion of the touch bezel 110 rather than the first touch event occurring on a first portion of the touch display panel 120, the processor 130 determines which one or more characters among the characters are to be further selected.

Moreover, similar to the embodiment of FIG. 5, in response to at least one second touch event occurring on a second portion of the touch bezel 110, the processor 130 determines which one character among the characters on the touch display panel 120 is selected. In an example, in the first determination, the at least one second touch event occurring on the touch bezel 110 can include a touch on the touch bezel 110 by a finger, and in the second determination, the at least one second touch event occurring on the touch bezel 110 can include one or more different fingers moving (such as rotating or scrolling) on the touch bezel 110 as shown in FIG. 9B. In another example, in the first determination, the at least one second touch event the touch bezel 110 can include a touch on the touch bezel 110 by a finger, and in the second determination, the at least one second touch event occurring on the touch bezel 110 can include the same finger moving on the touch bezel 110 as shown in FIG. 9C. It can be required that the touch event in the second determination occur while the touch event in the first determination is still occurring.

When the touch bezel 110 senses the touch event occurring sequentially or simultaneously on at least one portion of the touch bezel 110, the processor 130 determines to rotate, move, zoom in, zoom out, or scroll at least a portion of the content displayed on the touch display panel 120.

It is noted that although the wearable electronic device FIGS. 5 and 9A-9C is shown as to have a rectangular shape, it can have different shapes in other embodiments. For example, in an embodiment, it is circular. In addition, it is not required to groups the characters in the two stages of character selection. Specifically, in the generating the at least one control signal according to the combination of at least one scenario occurring on the touch display panel and the at least one second touch event, the processor can preliminarily select one or more characters (e.g., ‘O’) based on either the first touch event or the second touch event on the touch display panel or the display bezel performed by a finger (e.g., index finger). The one or more preliminarily-selected characters may be characters closest to the at least one first/second touch event, or in any locations predetermined to correspond to the touched area. The processor can then confirms to select at least one character of the one or more preliminarily-selected characters based on the at least one second touch event on the touch display panel or the display bezel performed by the same finger or at least one different finger on the display bezel. To this end, the moving of the finger(s) on the display bezel can confirm the preliminarily-selected character to be selected, or cause another character to be selected (e.g., ‘Q’, ‘P’ for a first moving direction or ‘N’, ‘M’, ‘L’ for second moving direction). In addition, the selected character(s) may be displayed in different forms/places on the touch display panel. More other details can be referred to description for the embodiment of FIG. 5, thus omitted here for brevity.

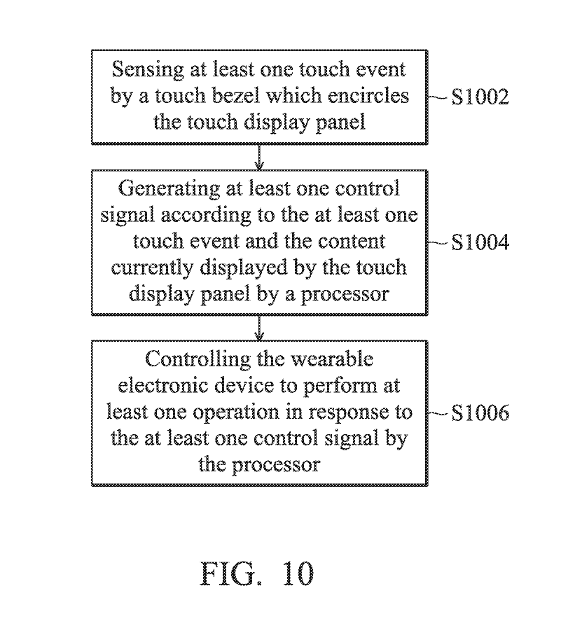

FIG. 10 is a flowchart illustrating another touch operation method for controlling a wearable electronic device according to an embodiment of the invention. Although illustrated as discrete blocks, various blocks may be divided into additional blocks, combined into fewer blocks, or eliminated, depending on the desired implementation. FIG. 10 may be applied in the embodiments of FIG. 7-FIG. 9 but is not limited thereto. Since the embodiment of FIG. 10 can be implemented in the wearable electronic device 10 in FIG. 1, it is explained below using reference numbers used in the embodiment of FIG. 1 but is noted limited thereto.

In step S1002, at least one touch event is sensed by a touch bezel 110 which is disposed around the touch display panel. Afterwards, in step S1004, at least one control signal is generated according to the touch event and according to the content currently displayed on the touch display panel 120 by a processor 130. In step S1006, the wearable electronic device 10 is controlled to perform at least one operation in response to the control signal by the processor 130. Details of each step may be analogized from the above embodiments, thus omitted here for brevity.

It should be noted that in some embodiments, the processor 130 generates the control signal according to a currently-executed application. In other words, the scenario occurring on the touch display panel 120 combined with the same touch event on the touch bezel 110 may represent different gestures or lead to different operations under different applications.

In addition, the current scenario can include both of the first touch event on the touch display panel 120 and the content currently displayed by the touch display panel. For example, when the wearable electronic device 10 is running an application for previewing a photograph or for viewing a taken photograph, the content currently displayed on the touch display panel 120 can be a current image captured by an image sensor or a camera of the wearable electronic device 10 or a photo in an album. Under such application, the user could touch the touch display panel 120 (the first touch event) for selecting an object in the image (the currently-displayed content), and touch the touch bezel 110 for zooming-in or zooming-out (the second touch event) the selected object. The first touch event and the second touch event occur sequentially. Therefore, the operation of viewing pictures could be performed according to a combination of the first touch event and the second touch event and the content currently displayed by the touch display panel.

Additionally or alternatively, the processor 130 generates the control signal according to a detection of whether a right hand or a left hand is holding/wearing the wearable electronic device 10. For example, for different hands detected to be holding/wearing the wearable electronic device, a user interface displayed on the touch display panel 120 can be shown differently to facilitate the operation of the detected hand. Alternatively and/or additionally, the touch event on the touch display panel 120 and/or the touch event on the touch bezel 110 required to trigger a specific operation of the wearable electronic device can be different when a different hand is detected to be holding the wearable electronic device 10. For example, a clockwise rotation required to trigger an operation may be replaced by a counter-clockwise rotation to trigger the same operation for different hands. Or a touch event on the right side of the touch bezel 110 may be replaced by a touch event on the left side of the touch bezel 110 to trigger the same operation.

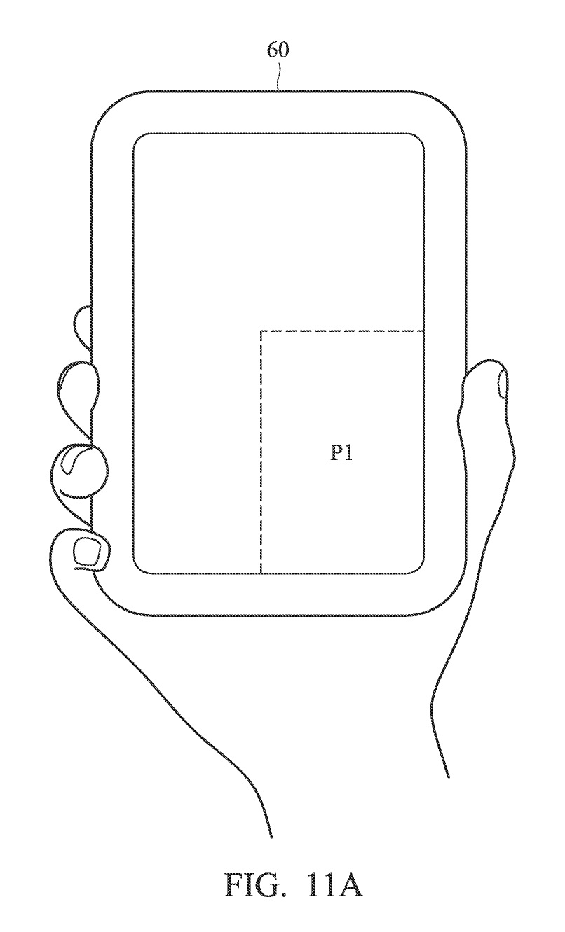

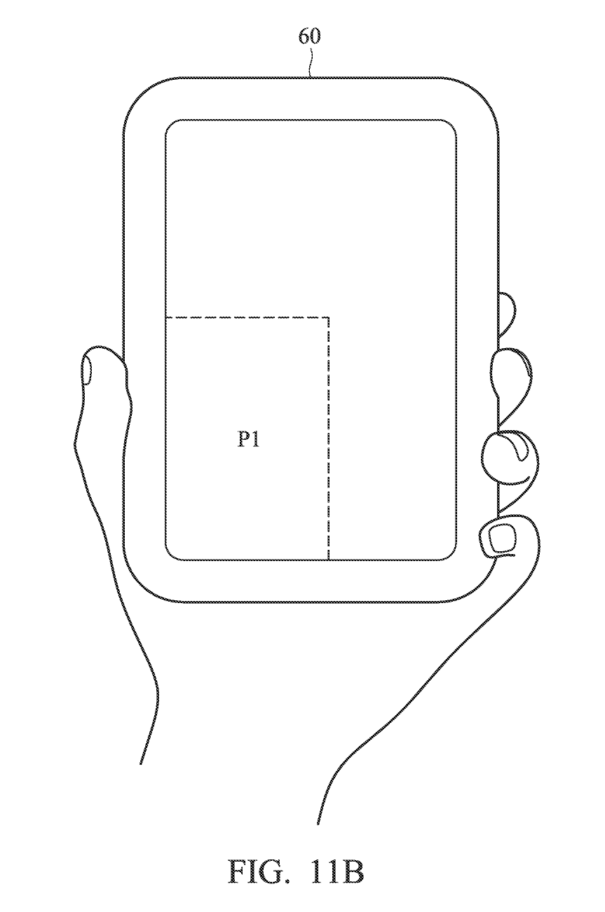

FIGS. 11A and 11B an example diagram of a mobile electronic device 60 according to an embodiment, illustrating that different user interfaces provided when different hands are holding/wearing the mobile electronic device. The mobile electronic device 60 may be a tablet, a mobile phone, or a wearable electronic device. In addition, the mobile electronic device 60 includes a display panel and a processor. The display panel may be implemented as a touch display panel and configured to display contents. The processor is configured to detect whether a right hand or left hand is wearing/holding the mobile electronic device 60, and provide different provide different user interfaces for the same functionality when a right hand or left hand is detected to wear/hold the mobile electronic device 60. The different user interfaces for the same functionality comprise different contents for the same functionality displayed on the display panel. The different contents for the same functionality displayed on the display panel comprise at least one partial content for the same functionality displayed. The partial content P1 may be closer to one side of the display panel when a right hand is detected to wear/hold the mobile electronic device 60 in FIG. 11A, and closer to one opposite side of the display panel when a left hand is detected to wear/hold the mobile electronic device 60 in FIG. 11B.

In the embodiments, since the touch bezel provides one or more extra touch areas, users can access the wearable electronic device more easily and conventionally. In addition, at least one scenario occurring on the touch display panel and at least one touch event occurring on the touch bezel can be considered in a combined way to determine a corresponding operation of the wearable electronic device. In other words, the touch bezel and the touch display panel can operate in a more integrated way, thus allowing users to operate the wearable electronic device in a more intuitive, fluent, and elegant way. Furthermore, the touch bezel and the touch display panel can be physically integrated to have a more integrated and hence stylish appearance.

Although embodiments of the present disclosure and their advantages have been described in detail, it should be understood that various changes, substitutions and alterations can be made herein without departing from the spirit and scope of the disclosure as defined by the appended claims. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufactures, compositions of matter, means, methods, or steps.

What is claimed is:

1. A wearable electronic device, comprising:
a touch display panel, configured to sense at least one first touch event and display content;
a touch bezel, disposed around the touch display panel, and configured to sense at least one second touch event; and
a processor, configured to generate at least one control signal according to a combination of at least one scenario occurring on the touch display panel and the at least one second touch event, and control the wearable electronic device to perform at least one operation in response to the at least one control signal.

2. The wearable electronic device as claimed in claim 1, the at least one scenario occurring on the touch display panel comprises the at least one first touch event occurring on the touch display panel.

3. The wearable electronic device as claimed in claim 1, the at least one scenario occurring on the touch display panel comprises a content currently displayed on the touch display panel.

4. The wearable electronic device as claimed in claim 1, wherein in controlling the wearable electronic device to perform the at least one operation in response to the at least one control signal, the processor determines content subsequently displayed on the touch display panel according to the combination of the at least one scenario occurring on the touch display panel and the at least one second touch event occurring on the display bezel.

5. The wearable electronic device as claimed in claim 2, wherein the combination of the at least one first touch event and the at least one second touch event comprises the at least one first touch event and the at least one second touch event occurring simultaneously.

6. The wearable electronic device as claimed in claim 2, wherein the combination of the at least one first touch event and the at least one second touch event comprises the at least one first touch event and the at least one second touch event occurring sequentially.

7. The wearable electronic device as claimed in claim 2, wherein in generating the at least one control signal according to the combination of the at least one first touch event and the at least one second touch event, the processor determines a first gesture according to the at least one first touch event and determines a second gesture according to the at least one second touch event, and generates the at least one control signal according to a combination of the first gesture and the second gesture.

8. The wearable electronic device as claimed in claim 2, wherein in generating the at least one control signal according to the combination of the at least one first touch event and the at least one second touch event, the processor determines a gesture according to a combination of the at least one first touch event and the at least one second touch event, and generates the at least one control signal according to the gesture.

9. The wearable electronic device as claimed in claim 2, wherein in generating the at least one control signal according to the combination of the at least one first touch event and the at least one second touch event, the processor generate the at least one control signal further according to at least one of a currently-executed application and a content currently displayed on the touch display panel and a detection of whether a right hand or a left hand is holding the wearable electronic device.

10. The wearable electronic device as claimed in claim 2, wherein the processor generates the at least one control signal according to a touched region where the at least one first touch event occurs on the touch display region and one or more rotations in the at least one second touch event occurring on the touch bezel.

11. The wearable electronic device as claimed in claim 10, wherein the processor further judges whether a predetermined unlocking condition is met according to the detections, and when the predetermined unlocking condition is met, the processor generates the at least one control signal for unlocking another device.

12. The wearable electronic device as claimed in claim 2, wherein when a plurality of groups of characters are displayed respectively on a plurality of portions on the touch display panel, the processor generates the at least one control signal for selecting one character from the plurality of groups of characters according to a combination of a touched portion of the plurality of portions on the touch display panel in the at least one first touch event on the touch display panel, and the at least one second touch event occurring on the touch bezel for further selecting one character from the group of characters in the touched portion.

13. The wearable electronic device as claimed in claim 3, wherein the processor determines to rotate, move, zoom in, zoom out, or scroll at least first part of the content displayed on the touch display panel according to the combination of at least one second part of the content displayed on the touch display panel and the at least one second touch event occurring on the touch bezel, the at least first part of the content different from or the same as the at least one second part of the content.

14. The wearable electronic device as claimed in claim 3, wherein when a plurality of characters are currently displayed respectively on a plurality first sub-portions of the touch display panel, the processor determines to sequentially display one character of the characters according to a combination of a touched portion of a plurality second portions of the touch bezel in the at least one second touch event occurring on the touch bezel and the character currently displayed on the first portion of the touch display panel corresponding to the touched portion of the touch bezel.

15. The wearable electronic device as claimed in claim 2, wherein when a plurality of groups of characters are displayed respectively on a plurality of first portions on the touch display panel, the processor generates the at least one control signal for selecting one character from the plurality of groups of characters according to a combination of a touched portion of a plurality of second portions on the touch display panel in the at least one first touch event on the touch display panel, and the at least one second touch event occurring on the touch bezel for further selecting one character from the group of characters in the second portion of the touch display panel corresponding to the touched portion of the touch bezel.

16. The wearable electronic device as claimed in claim 3, wherein in generating the at least one control signal according to the combination of the at least one first touch event and the at least one second touch event, the processor generate the at least one control signal further according to at least one of a currently-executed application and a detection of whether a right hand or a left hand is holding the wearable electronic device.

17. The wearable electronic device as claimed in claim 1, wherein the at least one second touch event comprise a combination of at least one first sub-touch event occurring on a first portion of the touch bezel and at least one second sub-touch event occurring on a second portion of the touch bezel.

18. The wearable electronic device as claimed in claim 1, wherein the at least one operation comprises texting, zooming, rotating and/or scrolling of at least one part of content displayed on the touch display panel.

19. The wearable electronic device as claimed in claim 1, the at least one scenario occurring on the touch display panel comprises the at least one first touch event occurring on the touch display panel and a content currently displayed on the touch display panel.

20. The wearable electronic device as claimed in claim 1, wherein in the generating the at least one control signal according to the combination of at least one scenario occurring on the touch display panel and the at least one second touch event, the processor selects one or more characters based on either the first touch event or the second touch event on the touch display panel or the display bezel performed by a finger, and confirms to select at least one character of the one or more selected characters based on the at least one second touch event on the touch display panel or the display bezel performed by the same finger or at least one different finger on the display bezel.

21. A touch operation method for a wearable electronic device, comprising
sensing at least one first touch event and displaying a content by a touch display panel;
sensing at least one second touch event by a touch bezel which is disposed around the touch display panel;
generating at least one control signal according to a combination of at least one scenario occurring on the touch display panel and the at least one second touch event by a processor; and
controlling the wearable electronic device to perform at least one operation in response to the at least one control signal by the processor.

22. The touch operation method as claimed in claim 21, the at least one scenario occurring on the touch display panel comprises either of both of the at least one first touch event occurring on the touch display panel and a content currently displayed on the touch display panel.

23. The touch operation method as claimed in claim 21, wherein in controlling the wearable electronic device to perform the at least one operation in response to the at least one control signal, the processor determines content subsequently displayed on the touch display panel according to the combination of the at least one scenario occurring on the touch display panel and the at least one second touch event occurring on the display bezel.

24. A mobile electronic device, comprising:
a display panel, configured to display contents;
a processor, configured to detect whether a right hand or left hand is wearing/holding the mobile electronic device and provide different provide different user interfaces for the same functionality when a right hand or left hand is detected to wear/hold the mobile electronic device, wherein the different user interfaces for the same functionality comprise different contents for the same functionality displayed on the display panel.

25. The mobile electronic device as claimed in claim 24, wherein the different contents for the same functionality displayed on the display panel comprise at least one partial content for the same functionality displayed closer to one side of the display panel when a right hand is detected to wear/hold the mobile electronic device and one opposite side of the display panel when a left hand is detected to wear/hold the mobile electronic device.
